(19) United States
(12) Patent Application Publication
(10) Pub. No.: US 2006/0033378 A1
(43) Pub. Date: Feb. 16, 2006

(54) Bin on wheels

(76) Inventors: Darren James Sargent, Gympie Qld 4570 (AU); David Ian O'Brien, Noosaville Qld 4566 (AU)

Correspondence Address: GRAYBEAL, JACKSON, HALEY LLP, 155 - 108TH AVENUE NE, SUITE 350, BELLEVUE, WA, 98004-5901, US

(21) Appl. No.: 11/200,673

(22) Filed: Aug. 10, 2005

(30) Foreign Application Priority Data
Aug. 10, 2004 (AU) 2004904474

(51) Int. Cl. B62B 1/00

(52) U.S. Cl. 298/6

(57) ABSTRACT

A bin 1 mounted on wheels is disclosed. The bin 1 comprises a support 2 having a pair of wheels 3 mounted there to. The support 2 also has a brake that can be selectively engaged by an operator to brake the wheels. A bin container 5 is rigidly mounted on the support 2. The bin container 5 comprises a front and a rear 10 and 12 and two sides 13, 14 extending between the front and the rear. The rear 12 forms a tailgate that is capable of being moved from a closed position in which it closes off the front and sides and an open position in which it defines an opening in the wall. Material such as soil or refuse can be loaded into the bin container 5 and discharged from the bin container through this opening. The bin 1 includes a draw pole 25 for attaching it to a towing vehicle. The bin container 5 can be tipped from a travelling position to a rearward tipping position in which the bin container 5 slopes down in a rearward direction by applying the brake to the at least one wheel 3 and then displacing the draw pole 25 rearward. This causes the draw pole 25 to pivot the bin 1. The tailgate 12 also includes a chain extending from the draw pole 25 to the tailgate 12 that automatically moves the tailgate 12 from the closed to the open position in response to tipping of the bin container 5 into the rearward tipping position.

### FIELD OF THE INVENTION

This invention relates to a bin on wheels.

This invention relates particularly to a bin on wheels that is suitable for connection to a towing vehicle so that the towing vehicle can tow it from one location to another. Such a bin on wheels might have a surface area when viewed in plan view that is comparable to a back yard or DIY trailer that can be coupled up to a car and used to deliver material such as refuse or soil from one location to another. It will therefore be convenient to hereinafter describe the invention with reference to this example application. However it is to be clearly understood that this invention is capable of broader application.

For example the invention could be used for any bin, including a skip, that is used to carry a flowable material. For example a bin on wheels could be implemented on a size that is considerably larger than a DIY trailer. It could be used on an industrial skip of several cubic metres volumetric displacement.

### DEFINITIONS

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

In this specification the term “bin” shall be interpreted broadly and include all contrivances having a bin container for carrying a flowable material to transfer it from one location to another. Specifically it includes containers with walls in which material is fed in through the top of the container and in which material is discharged through the top of the container. Further in the specification the term bin shall be understood to include within its scope a skip.

### BACKGROUND TO THE INVENTION

A bin including a skip can be used for carrying flowable material such as rubbish, soil or the like. Typically the bin comprises a bin container having a floor and four side walls extending up from the floor. The side walls define an open top through which material is introduced to the container and discharged from the container.

Typically the walls are rigid and are fixed in a single position. That is none of the walls is capable of being moved or swung open to an open position. In particular the rear wall is rigid and permanently attached to its adjacent side walls and cannot be opened.

A characteristic of these bins is that the floor sits on the ground. Accordingly to move the bin across the ground it has to be lifted up. Typically this is done by lifting it up onto the load bed of a truck. However this requires a truck of quite a large size just to provide a load bed of sufficiently large size. Further lifting apparatus, eg in the form of a specialised hoisting mechanism, such as a crane, is needed to lift the bin up off the ground and onto the load bed. Typically the bin might be lifted up to a height of at least one meter.

A shortcoming of these bins is that they cannot be moved across the ground without being lifted up. Accordingly, moving the bins is a fairly complex process requiring special hosing equipment and special transport vehicles.

Clearly therefore it would be advantageous if a bin could be devised that could simply be coupled up to a tow vehicle and towed behind the vehicle on a road from one location to another.

This would obviate the need for a vehicle with a suitable load bed and also the equipment needed to load it onto a load bed. It would yield a bin that was suitable for carrying loads from one location to another in a more informal or simple manner.

It would also be advantageous if such a bin had a mechanical contrivance for tipping the bin to empty a load of flowable material within the container. That way the material would flow out of the container and it would not be necessary to physically shovel the material out of the container. In particular it would be advantageous if the bin had a wall portion, eg towards the rear, that opened to permit material to be discharged from the container.

### SUMMARY OF THE INVENTION

According to one aspect of this invention there is provided a bin mounted on wheels, the bin comprising:

a support having a pair of wheels mounted there to for displacing the support across a support surface;

a bin container rigidly mounted on the support, the bin container comprising a floor and a peripheral wall extending up from the floor around the periphery of the floor, a portion of the peripheral wall being capable of being moved from a closed position in which it closes off the peripheral wall and an open position in which it is moved away from the rest of the wall to define an opening in the wall through which material can be loaded into the bin container and discharged from the bin container;

means for facilitating tipping the bin container from a normal travelling position to a rearward tipping position in which the bin container slopes down in a rear ward direction;

means for causing the portion of the wall to move to the open position in response to said tipping of the bin container into the tipping position whereby to facilitate loading or unloading of the bin container; and

a draw pole for attaching the bin to a towing vehicle, the draw pole being pivotally mounted to the support or the bin container by means of a pivotal coupling and extending there from in a forward direction.

Thus the bin is mounted on wheels and has means for facilitating tipping of the container to a tipping position and also means for opening a portion of the wall to facilitate discharge of material from the bin container.

The bin may be a skip.

The bin container may have a front and a rear and two sides extending between the front and the rear. Further the portion of the wall that moves between the open and closed positions may be the rear of the bin container and this may form a tailgate.

The wall portion moving means may be a tailgate moving means that moves the tailgate between the open and closed positions. The tailgate moving means may comprise a flexible elongate element that has one end mounted to the draw pole and has an opposed end mounted to the tailgate or a component that moves with the tailgate. The flexible element has a path that is altered by movement of the bin container. Thus when the bin container is moved to the tipping position the alteration in the path causes the flexible element to effectively move the tailgate to the open position.

There may be two laterally spaced said flexible elements extending up the front of the bin container, one towards each side of the container. The flexible element may extend from the draw pole proximate to the front of the bin container up the front of the bin container to an attachment on the tailgate or a component that moves with the tailgate. Each flexible element may be a chain.

The bin container tipping means may comprise a brake that is operatively mounted on at least one wheel and that can be selectively engaged by an operator to brake said at least one wheel. The bin container may be tipped by applying the brake to the at least one wheel and then displacing the draw pole rearward by means of a towing vehicle and this rearward displacement of the vehicle and thereby also the draw pole may cause the bin container to tip.

The brake may comprise two brake members applying a braking action to both wheels on the bin. The brake may further include a controller for enabling a user to operate the brakes that is remote from the bin. For example the controller may be located in the towing vehicle. Further the controller may be operatively coupled to the brake members by means of a cable.

The bin container tipping means may also comprise a lifting means that is mounted on the draw pole and which can be operatively coupled to the bin container to lift the front of the bin container. The lifting means may be a winch that is mounted on the draw pole and extends upwardly there from to a height above the floor of the bin container. The winch may have a cable and attachment formation that can be releasably attached to a complementary formation on the bin container to lift the front of the container up.

The bin container tipping means may also comprise a cam that operatively engages an underside of the floor of the bin container towards the front thereof and a lever extending away from the cam, whereby pivoting of the lever rotates the cam relative to the bin container and lifts leading edge of the container.

The tailgate may include at least one arm having a front end and a rear end and the tailgate may be mounted to each arm towards its rear end. The arm may be pivotally mounted to the bin container at a point spaced away from the rear end whereby pivoting of each arm on the container moves the tailgate between the closed and open positions.

The tailgate may include two said arms, one each resting on the upper edge of a side of the bin container. The arms may rest on an upper edge of the bin container. Further the two arms may be operatively connected to each other to form an arm frame, eg by two or more cross members. Preferably there are cross members extending between the front and rear of the arms.

The arms may be pivotally mounted on the upper edge of the bin container at a pivot point which is closer to the front than the rear of the bin container.

The upper edges of the sides of the bin container may slope up from the rear to the pivot point and also and slope from the front of the bin container to the pivot point. This feature of the upper edges sloping up from both the front and rear to the intermediate pivot point provides clearance for the arms to move the tailgate from the closed to the open position without interference from the sides of the bin container.

The sloping upper edges of the sides of the container may effectively provide stop formations for stopping further movement of the arms when the tailgate when it is in each of the open and closed positions.

Each flexible element described above may be mounted to a said arm. The flexible element may be mounted to the arm towards the front of the bin container.

The bin may further include at least one compression strut extending between one side of the bin container a said arm that moves with the tailgate, the strut being mounted to the bin container at a position rearward of the pivotal mounting of the arm to the bin container.

The bin may have a said compression strut on each side of the bin container, each said compression strut extending between the side of the bin container and the arm on the associated side of the bin container.

The bin may further include a rigid arm or strut that can be removably placed between the bin container and the arm when the tailgate is in the open position to hold it in the open position.

The bin container may further include a lid for covering over the top of the container. The lid may be mounted on the arm frame of the tailgate and move with the arms when the tailgate moves between the open and closed positions.

The lid may comprise at least one lid portion that is pivotally mounted on the arm frame of the tailgate and is movable between a closed position in which it rests on the arm frame and closes the top of the bin container and an upwardly extending open position in which it provides access to the interior of the bin container.

The lid may comprise two said lid portions arranged side by side on the arm frame. Each lid portion may be pivotally mounted on the arm frame towards the front of the bin container, and each lid portion may be capable of being pivoted from the closed position up into the open position.

The draw pole may comprise left and right arms and each of said left and right arms may be pivotally mounted to the support by means of a pivotal coupling. The pivotal couplings that pivotally mount the left and right arms of the draw pole to the support may be located forward of the wheels of the bin.

The bin may further include bin container locking means for releasably locking the bin container in the normal running position to ensure that it does not inadvertently move to the tipping position when it is being towed by a vehicle on a road. The bin container locking means may comprise an over cam pivotally mounted on the draw pole and a complementary locking formation on the front of the bin container that can be releasably engaged by the over cam.

The bin may further include tailgate locking means for releasably locking the tailgate in the closed position to ensure that it does not inadvertently move to the open position when the bin is being towed by a vehicle on a road.

The tailgate locking means may comprise a locking formation on the tailgate and a complementary locking formation on the bottom or sides of the container towards the rear thereof.

According to another aspect of this invention there is provided a bin mounted on wheels, the bin comprising:

a support having a pair of wheels mounted there to for displacing the support across a support surface;

a bin container rigidly mounted on the support, the bin container comprising a front and a rear and two sides extending between the front and the rear, the rear forming a tailgate that is capable of being moved from a closed position in which it closes off the peripheral wall and an open position in which it is moved away from the adjacent sides of the bin container to define an opening in the wall through material can be loaded into the bin container and discharged from the bin container;

means for facilitating tipping of the bin container from a normal running position to a rearward tipping position in which the bin container slopes down in a rear ward direction;

means for automatically moving the tailgate from the closed to the open position in response to tipping of the bin container into the rearward tipping position; and

a draw pole for attaching the bin to a towing vehicle, the draw pole being pivotally mounted to the base or the bin container and extending therefrom in a forward direction;

The bin may include any one or more of the optional or preferred features of the invention as described in the first aspect of the invention above.

According to yet another aspect of this invention there is provided a bin mounted on wheels, the bin comprising:

a support having a pair of wheels mounted there to for displacing the support across a support surface, and a brake that is operatively mounted on at least one wheel that can be selectively engaged by an operator to brake said at least one wheel;

a bin container rigidly mounted on the support, the bin container comprising a front and a rear and two sides extending between the front and the rear, the rear forming a tailgate that is capable of being moved from a closed position in which it closes off the peripheral wall and an open position in which it is moved away from the adjacent sides of the bin container to define an opening in the wall through material can be loaded into the bin container and discharged from the bin container;

a draw pole for attaching the bin to a towing vehicle, the draw pole being pivotally mounted to the base or the bin container and extending therefrom in a forward direction; and

means for automatically moving the tailgate from the closed to the open position in response to tipping of the bin container into the rearward tipping position;

wherein the bin container can be tipped from a travelling position to a rearward tipping position in which the bin container slopes down in a rearward direction by applying the brake to the wheel/s and then displacing the draw pole rearward with a towing vehicle and this causes the tailgate moving means to move the tailgate into the open position.

The bin may include any one or more of the optional or preferred features of the invention as described in the first aspect of the invention above.

### DETAILED DESCRIPTION OF THE PREFERRED EMBODIMENTS

A bin on wheels in accordance with this invention may manifest itself in a variety of forms. It will be convenient to hereinafter provide a detailed description of one embodiment of the invention with reference to the accompanying drawings. The purpose of providing this detailed description is to instruct persons having an interest in the subject matter of the invention how to put the invention into practice. It is to be clearly understood however that the specific nature of this detailed description does not supersede the generality of the preceding statements. In the drawings:

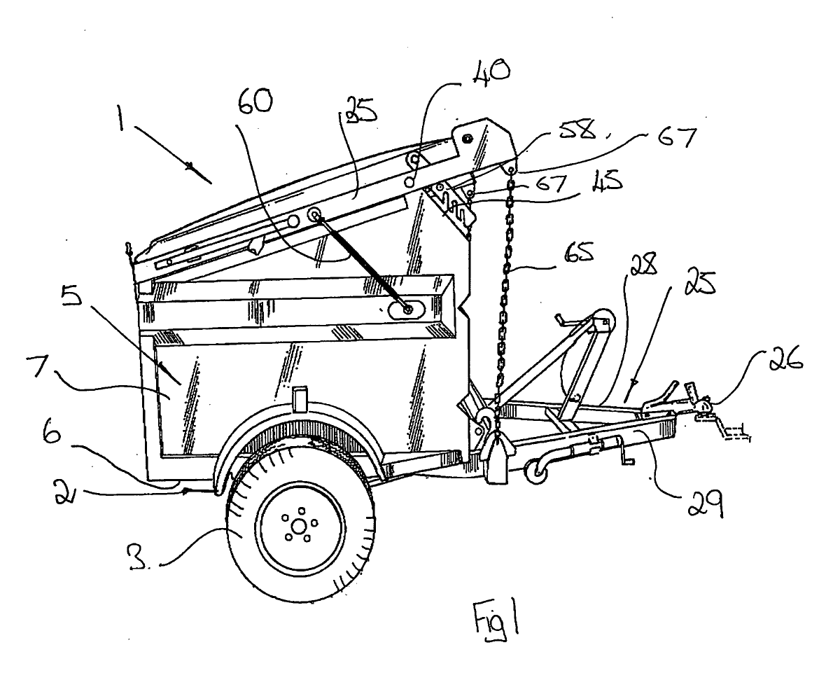

FIG. 1 is a side view of a bin on wheels in a normal running position and with the tailgate in a closed position;

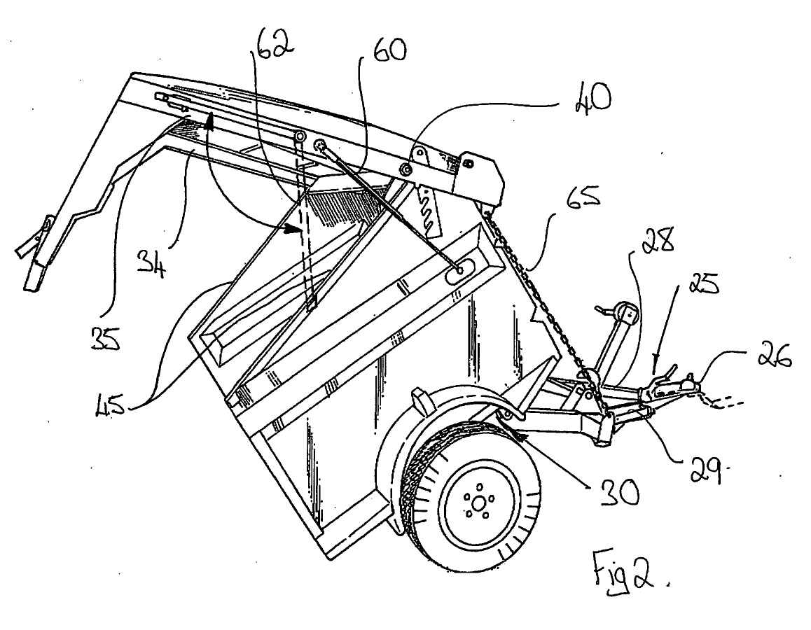

FIG. 2 is a side view of the bin of FIG. 1 in a tipping position and with the tailgate in an open position;

FIG. 3 is a side view of the bin of FIG. 1 coupled to a tow hitch of a vehicle and in the normal running position;

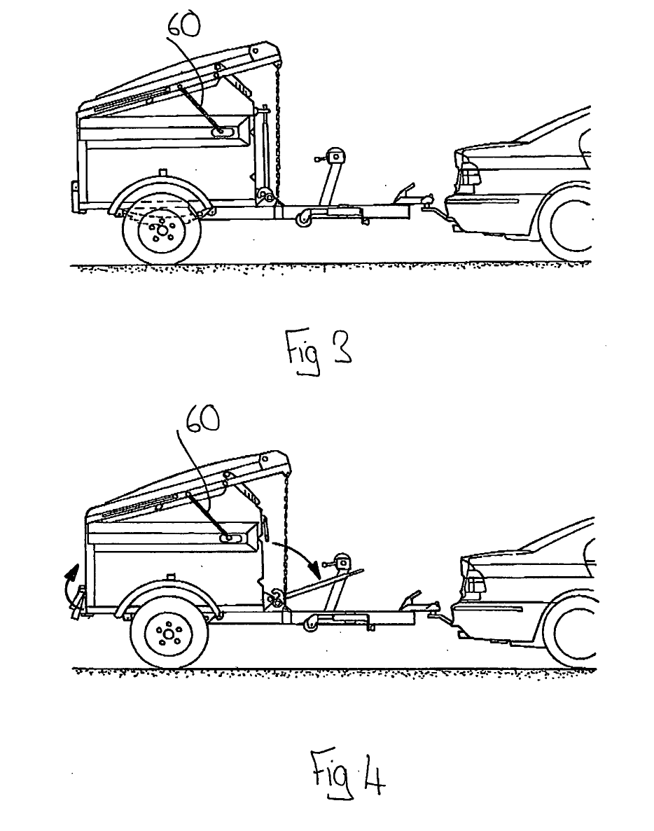

FIG. 4 is a side view of the bin of FIG. 3 after locks for locking respectively the bin container and the tailgate have been released;

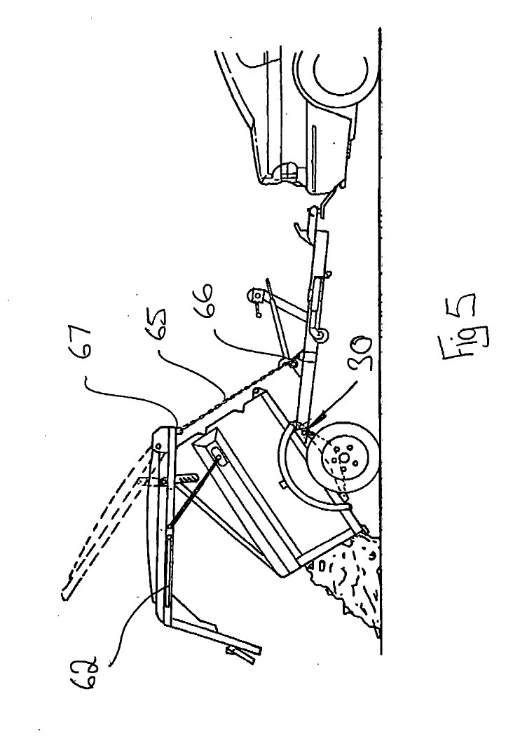

FIG. 5 is a side view of the bin of FIG. 3 in which the bin container has been moved to a tipping position and the tailgate has been moved to an open position;

FIG. 6 is a rear three dimensional view of the bin of FIG. 3 with the components in the same position as shown in FIG. 6;

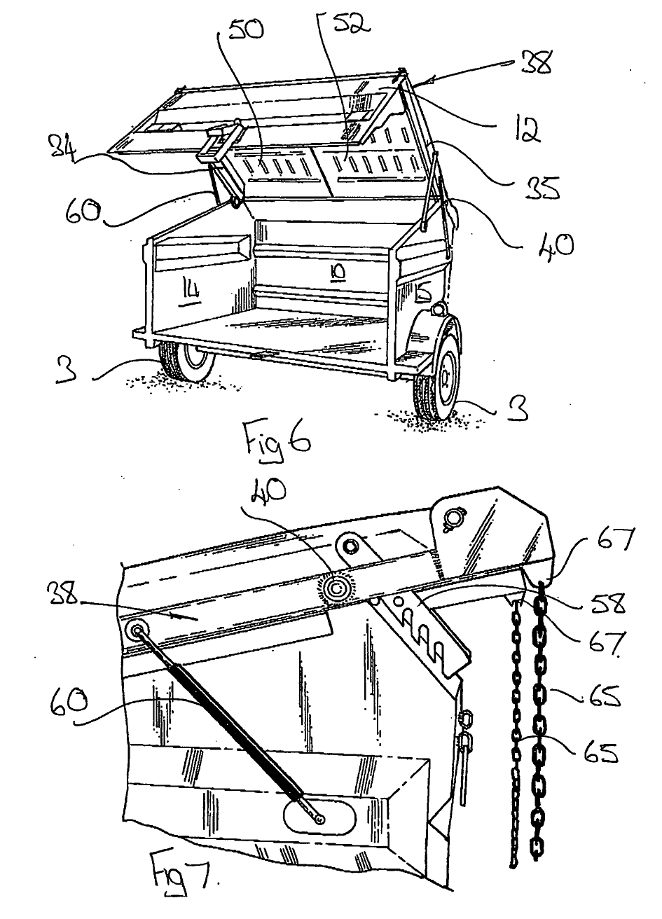

FIG. 7 is a side view showing detail of an upper region of the bin container towards the front of the bin container;

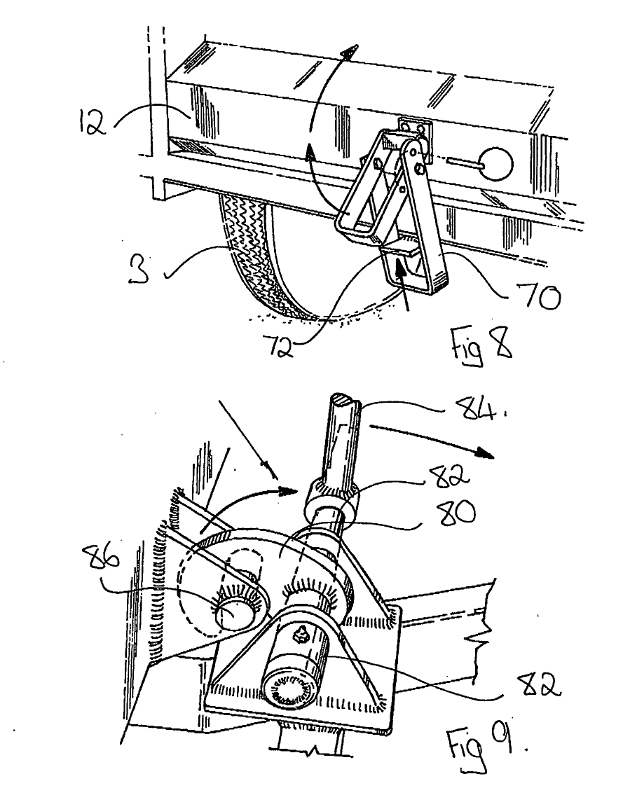

FIG. 8 is a rear three dimensional view of a lock for locking the tailgate in the closed position;

FIG. 9 is an upper three dimensional view of a lock for locking the bin container in the normal travelling position;

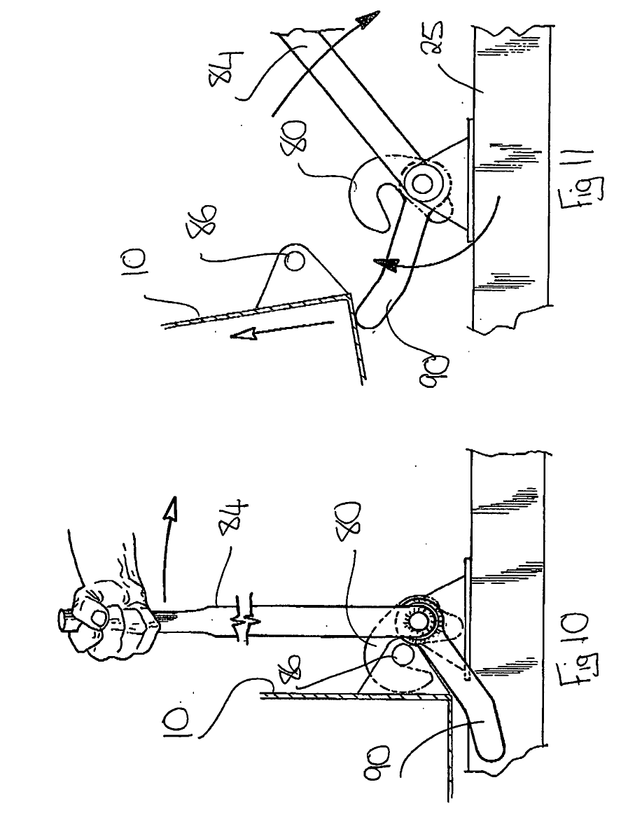

FIG. 10 is a side view of the front of the bin container and a cam and lever for facilitating manual pivoting of the bin container to the tipping position, the bin container being shown in the normal running position;

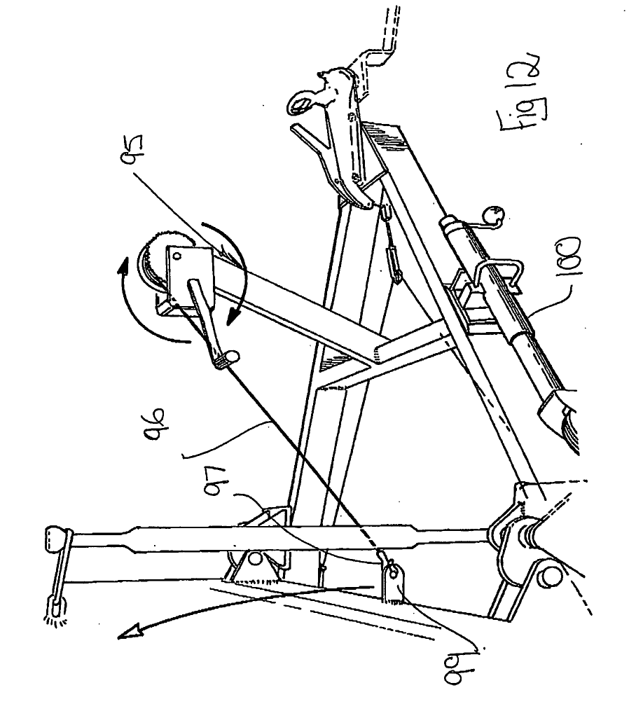

FIG. 11 shows the cam and lever after it has raised the bin container towards the tipping position; and

FIG. 12 is an upper three dimensional view of the draw pole and front of the bin container showing some detail.

In FIGS. 1 to 8 reference numeral 1 refers generally to a bin in accordance with the invention.

The bin on wheels 1 comprises broadly a support 2 having wheels 3 mounted on it and a bin container 5 mounted on the support 2. The bin container 5 comprises a floor 6 having a peripheral wall 7 extending up from the floor 6. The wall 7 has a front and a rear 10, 12 and left and right sides 14, 15 extending between the front and the rear 10, 12. The rear 10, 12 forms a tailgate that is capable of being moved from a closed position (FIG. 1) to an open position (FIG. 2) to permit material to be loaded into and discharged from the bin container 5. The bin 1 also includes a lid 20 mounted on the bin container 5.

The bin 1 further includes a draw pole 25 having a front end fitted with a coupling 25 for attaching it to a tow hitch of a vehicle. The draw pole 25 comprises left and right pole sections 28, 29 extending rearward from the front end to laterally spaced rear ends that are pivotally mounted to the support or the floor of the bin container by means of pivotal mountings 30.

The support 2 is in the form of a sub frame that includes a perimeter frame section that corresponds to the rectangular shape of the bin container 5. Left and right wheels 3 are mounted on the sub-frame in the usual way by means of a transverse wheel axle (not shown). The wheels 3 are positioned about halfway along the length of the bin container 5. That is they are positioned in about the middle of the sides 14, 15 of the bin container 5. The bin 1 is capable of tipping both forward and rearward relative to the transversely aligned wheels as would be usual for a trailer having only two such wheels.

The bin 1 also includes brakes for braking the left and right wheels on demand. The brakes comprise braking members associated with each of the left and right wheels for engaging the left and right wheels to exert a braking action, a brake cable and a controller. The controller enables a user to control the brakes from a position spaced away from the wheels of the bin. The brake controller might typically be mounted to a towing vehicle and be operated from inside the towing vehicle. The brake is used to brake the wheels and thereby permit rearward displacement of a towing vehicle to cause the bin container to tip from a horizontally extending normal running position to a rearward sloping tipped position. The tipping action of the bin container will be described in more detail below.

The tailgate 12 is mounted on the bin container 5 by means of laterally spaced left and right arms 34, 35. These arms 34, 35 are pivotally mounted to respectively left and right sides 14, 15 of the bin container 5. The laterally spaced left and right arms 34, 35 are attached together by means of cross members which together with the arms form a tailgate arm frame. The frame 38 might include at least two cross members extending between the left and right arms, eg towards front and rear ends of the arms, to form a rigid frame. The arm frame 38 moves as a single unit together with the tailgate 12 between the open and closed positions shown in FIGS. 1 and 2.

The upper edge 45 of the left and right sides of the container 5 slope upwardly from the rear 12 towards the tailgate arm hinge 40 at which it is at its highest point. From the tailgate arm hinge 45 the upper edge 45 of the side slopes downwardly to the front 10 of the bin container 5. The tailgate arm frame 38 is pivotally mounted on the upper edges of the left and right sides of the bin container by means of a tailgate arm hinge 40.

Each arm 34, 35 of the arm frame 38 is mounted on a said upper edge 45 of the sides of the container 5. The sloping upper edge permits free movement of the arms 34, 35 between the open and closed positions. It also provides stop formations for stopping travel of the arms 34, 35 once they have reached either the open or closed positions as the case may be. In the closed position the arms 34, 35 rest up against the upwardly sloping portion of the upper edge 45 towards the rear of the container 5. In the open position the arms 34, 35 lie up against the downwardly sloping portion of the upper edge 45 towards the front 10 of the container 5.

The lid 20 described above is mounted on the tailgate arm frame 38 and moves together with the tailgate arm frame 38 between said closed and open positions.

The lid 20 comprises two side by side lid portions 50, 52, each of which is pivotally mounted to the arm frame 38 towards the front of the bin container 5 by means of a lid hinge bar 55. Each lid portion 50, 52 can be manually lifted from a closed lid position (shown in FIGS. 1 and 2) to an open lid position shown in FIG. 5. Each of the lid portions 50, 52 may be held in the open lid position by means of a lid locking ratchet 58 shown in FIGS. 1, 2 and 7 that can be set in one of a number of different positions corresponding to different heights of the lid portion 50, 52.

Each lid portion 50, 52 may conveniently be made of plastic so that it is light and can be easily lifted up to the open position.

The bin 1 also includes compression struts 60 extending from left and right sides 14, 15 of the bin container 5 up to left and right arms 34, 35 of the tailgate 12. The compression struts 60 assist in manually lifting the tailgate 12 into an open position, eg when the container 5 is in its normal running position and is not being tipped. The struts 60 also assist in holding the arms 34, 35 and associated lid 20 and tailgate 12 in an open position.

The compression struts 60 are typically gas struts much like the struts used on hatch vehicles to hold the hatch in an open position.

The bin 1 also includes a rigid arm or prop 62 that is provided on the bin container and can be mounted in an operative position in which it extends upwardly from a side of the bin container, towards the upper edge thereof, to a said arm of the tailgate. This holds the arm frame and tailgate and associated lid in the open position and ensures that the arm frame does not drop when a person is positioned beneath it. It is thus something of a safety feature.

The tailgate arm hinge is located nearer the front than the rear of the bin container by some considerable distance. The reason for this is that a given pivot of the front of the tailgate arm frame will produce a much greater lifting of the tailgate away from the floor and sides of the bin container. It thus confers a form of mechanical advantage which enables the tailgate to be opened efficiently.

The bin also includes means in the form of a mechanism for physically moving the tailgate to the open position. The mechanism comprises a chain that has one end mounted to the draw pole and an opposed end mounted on a bracket on the tailgate arm frame. Thus the chain extends up over the front of the bin container. As shown in the drawings (FIG. 7) the mechanism comprises two laterally spaced chains extending up from the arms of the draw pole to the front end of the cleft and right arms. The front ends of the arms are located proximate to the front end of the bin container. When the bin container is tipped rearward the arm frame hinge portion is moved up to the left and the front of the arms is pulled down by the inextensible chains in response to this movement. This pivots the tailgate into the open position.

The bin also includes a locking means for locking the tailgate in the closed position. The locking means is shown in FIG. 8. It comprises a U-shaped locking bracket 70 pivotally mounted on the tailgate 12 and a passive locking formation 72 which is a flat projecting rearward out from a rear of the floor of the container. The U-shaped bracket 70 is pivoted down from a horizontally extending position to a vertically downward position around the passive locking formation 72 that resists any upward movement of the tailgate 12. As shown in the drawings the U-bracket is moved into an over centre position.

The bin also includes bin container locking means for locking the front 10 of the bin container 5 to the draw pole 25. This would usually be done when the bin 1 is being used for transport on the road and is in the normal running position. As shown in FIG. 9 the locking means comprises an over cam or hook formation 80 that is mounted on a bar 82 that is pivotally mounted on the draw pole 25 and a lever with a handle 84 for rotating the over cam 80. It also includes a complementary locking formation 86 on the bin containers over which the over cam or hook formation 80 is passed in the locked position (FIG. 3). The lever 84 is rotated forwards to unlock the bin container 5 from the draw pole 25 and permit the bin container 5 to tip rearward.

The bin 1 may also include a tipping assist bar 90 that is mounted under the front edge 10 of the bin container 5. The tipping assist bar can be pivoted upwardly to tip the front of the bin container 5 upwardly at least a short distance towards the tipping position but not fully into the tipping position.

In the illustrated embodiment the tipping assist bar 90 is mounted on the same bar 82 as the over cam 80 and is operated by the same lever and handle 84 as the over cam 80. This is shown clearly in FIGS. 10 and 11. When the lever 84 is being used an initial rotation of the lever 84 unlocks the over cam or hook formation 80 from the bin container 5. Then further rotation of the lever 84 causes the tip assist bar 90 to lift up the front of the bin container 5. As shown in the drawings it does not lift the bin container 5 up to a point where it moves into the tipping position of its own accord. However it performs an initial lift of the bin container 5 and makes it relatively easy for a person to manually tip the container to a further point from where it moves to the tipping position of its own accord. Thus the assist bar 90 considerably assists the process of moving the container 5 to the tipping position. It performs the initial lift of the container and from this point it is relatively easy to manually complete the process.

The bin further includes a winch 95 mounted on the draw pole 25 as shown in FIG. 12. The winch 95 has a winch cable and a hook 97 at the end of the winch cable. The winch 95 is mounted on a support post 98 that extends up from the draw pole 25 to a height some distance above the bottom of the container 5. The bin 1 also includes a bracket 99 on the bin container 5 longitudinally aligned with the winch 95. The hook 97 on the winch cable can be attached to the bracket 99 and then the cable 96 is reeled in. This lifts the bracket 99 and bin container 5 up out of the normal running position towards the tipping position. Thus the winch 95 provides yet another mechanical contrivance to move the bin container 5 into the tipping position.

The draw pole also includes a jockey wheel 100 are would be usual on a typical trailer for DIY use.

In use the bin on wheels may be used to transport material, eg flowable material, from one site to another. The flowable material could be stone, soil, topsoil, rubble cuttings, general refuse or the like. The bin will be used in the same manner no matter what material is being carried.

Typically the first step in a use of the bin would be to move the bin to the site where the material is located that has to be transported in the bin. A towing vehicle would be used to move the bin to the site.

Thereafter the material needs to be loaded onto the bin. To do this the tailgate and associated arm frame is moved to the open position. This can be done manually lifting the arm frame of bin container. The lid portions which are mounted on the arm frame naturally also move with the arm frame to the open position. The gas struts assist with this lifting process and also help to hold the tailgate and arm frame in the open position once they have been lifted up. In addition once the tailgate is in the open position the safety prop can be mounted in position between the side of the bin container and the arm to hold it securely in the open position.

There after material can be loaded into the bin container. As shown in FIG. 6 the raised tailgate provides access to the bin container in a side ways direction. Material does not have to be lifted above the side wall and then dropped in through the top of the container. It only has to be lifted up above the level of the floor. Once the arm frame has been loaded the tailgate and arm frame is manually pulled down to a closed position. During the loading process the draw pole remains coupled to the tow hitch of the towing vehicle.

An alternative way of loading the bin container with material would be to simply lift up a lid portion above the arm frame and hold it in this position using the locking ratchet. Material could then be placed in through the open top of the bin container. A disadvantage with this method is that the material has to be lifted above the level of the wall before it can be placed in the container. The lid portion is shown lifted off the arm frame in FIG. 5 although the tailgate is not closed in FIG. 5 and it does not show the loading process.

The bin is then readied for travel on the road. The front of the bin container is locked down onto the draw pole using the over cam and complementary locking formation on the bin container described above and illustrated in FIGS. 9 and 10. In addition the tailgate is locked to the floor of the bin container. This is done by pivoting the U bracket down and around the flat sticking out from the floor of the bin container as shown in FIG. 8. This ensures that the bin container cannot tip during travel and the tailgate cannot fly open.

Once the bin reaches its destination these two locks on respectively the tailgate and bin container are released. This is done in a reverse manner to the locking step described above.

There after the brake is applied to the wheels so that they will resist displacement in a reverse direction. Then the towing vehicle is reversed and this displaces the draw pole rearwardly. As the wheels cannot move back the bin container is caused to tip rearward. As this happens the chains pull down on the front of the arms and open the tailgate. This causes material to discharge through the rear of the container. As will be readily noted the bin container tips automatically and the tailgate opens automatically and the whole process can be carried out by a single driver within the towing vehicle.

If necessary a user can enter into the bin container and physically remove material from the container using a shovel or the like. When this process has been completed the vehicle is moved forward and this pulls the bin container back into the normal running position and also drops the tailgate back into the closed position. The brakes are then released and the bin container and tailgate locks are locked again. This completes the process and the vehicle can again be taken onto the road and driven on the road.

The description above has described how the brakes can be used to tip the bin container automatically. However there are other mechanical contrivances on the bin to achieve this same function. Basically the hook on the winch cable can be attached to the bracket on the front of the bin container and reeled in to lift the bin container towards the tipping position. Further the tip assist bar may be pivoted by the lever handle to lift the front of the bin container up to achieve the same effect. Thus the bin provides several options for tipping the bin container.

In another embodiment of the invention that has not been illustrated the bin has a winch but neither a brake on the wheels of the trailer nor a tipping assist bar. In yet another embodiment of the invention the bin has a tipping assist bar as described above but neither a winch nor a brake on the wheels.

In yet another embodiment of the invention the bin has a winch and a tipping assist bar but not a brake on the wheels. In yet another embodiment the bin has a tipping assist bar and a brake on the wheels but not a winch. Finally in yet another embodiment the bin has a winch and a tipping assist bar but not a brake on the wheels.

An advantage of the bin on wheels described above with reference to the drawings is that it can simply be towed by a towing vehicle that could be a normal car. It can simply be coupled up to a car by means of a tow hitch in the usual way and then driven around. It does not need to be lifted onto a special vehicle to be transported from one location to another. Further it does not need to be lifted up. It can be used with any suitably powered vehicle.

A further advantage of the bin on wheels described above is that the tailgate can be opened and closed on demand to facilitate loading and unloading of the bin container. It is thus not necessary to lift material up to the height of the bin container and then load it in through the open top. It can simply be loaded in side ways through the open tail gate.

A yet further advantage of the bin on wheels is that it has contrivances for causing the bin container to tip rearwardly on demand. One such contrivance comprises applying the brakes on the bin wheels and then reversing the draw pole into the bin container to cause it to tip. This contrivance has the advantage that is uses the motive power in the towing vehicle to effect the tipping and it does not require any exertion by an operator. Further it can be done solely by a driver within the towing vehicle and does not require a person outside the vehicle to assist in the process.

Another such contrivance uses a cam and lever to tip the front of the container to a point where it would be relatively easy to pivot the container further to an over centre position from where it moves of its own accord into the tipping position. The cam and lever are sized and positioned to make this a relatively simple task for a sophisticated user with modest physical strength. It does not require the strength of a strong adult male to tip the bin container into the tipping position.

Another such contrivance uses a winch positioned on the draw pole to lift up the front of the bin container. A hook at the end of the cable for the winch is attached to a formation on the front of the container and the winch is reeled in to lift the bin container up into a position from where it moves into the tipping position.

A yet further advantage of the bin container described above is that the tailgate automatically opens in response to tipping of the bin container into the tipping position. As the bin container tips rearwardly the tailgate and lid lifts upwardly permitting material to discharge from the container. This feature is very useful where the bin and towing vehicle are being operated by a single person as it does not require an independent operator to open the tailgate. Further the tailgate drops back into the closed position when the bin container is moved back into its normal running position.

A yet further advantage of the bin described above is that it manufactured from proven mechanical components and is very reliable in operation. In addition it requires very little maintenance.

Finally the bin described above fills a niche that has not previously been catered to by manufacturers of trailers and skips and bins. Currently Applicant is not aware of any DIY bins or skips and the nearest piece of apparatus to this bin is a simple 6 by 4 trailer with a cage on the top. The bin described above offers numerous features and advantages over this known piece of apparatus and in particular the ease with which it can be loaded and then tipped and unloaded. It drastically reduces the amount of work required to be done by the operator of the trailer or bin and the physical effort required to be put in by them to operate the bin.

It will of course be realised that the above has been given only by way of illustrative example of the invention and that all such modifications and variations thereto as would be apparent to persons skilled in the art are deemed to fall within the broad scope and ambit of the invention as herein set forth.

1. A bin mounted on wheels, the bin comprising:
a support having a pair of wheels mounted there to for displacing the support across a support surface;
a bin container rigidly mounted on the support, the bin container comprising a floor and a peripheral wall extending up from the floor around the periphery of the floor, a portion of the peripheral wall being capable of being moved from a closed position in which it closes off the peripheral wall and an open position in which it is moved away from the rest of the wall to define an opening in the wall through which material can be loaded into the bin container and discharged from the bin container;
means for facilitating tipping the bin container from a normal travelling position to a rearward tipping position in which the bin container slopes down in a rear ward direction;
means for causing the portion of the wall to move to the open position in response to said tipping of the bin container into the tipping position whereby to facilitate loading or unloading of the bin container; and
a draw pole for attaching the bin to a towing vehicle, the draw pole being pivotally mounted to the support, or the bin container by means of a pivotal coupling and extending there from in a forward direction.

2. A bin according to claim 1, wherein the bin container has a front and a rear and two sides extending between the front and the rear, and the portion of the wall that moves between the open and closed positions is the rear of the bin container that forms a tailgate.

3. A bin according to claim 2, wherein the wall portion moving means is a tailgate moving means that moves the tailgate between the open and closed positions.

4. A bin according to claim 3, wherein the tailgate moving means comprises a flexible elongate element that has one end mounted to the draw pole and has an opposed end mounted to the tailgate or a component that moves with the tailgate, and the flexible element has a path that is altered by movement of the bin container and this alteration of the path causes the flexible element to move the tailgate to the closed position.

5. A bin according to claim 4, wherein there are two laterally spaced said flexible elements extending up the front of the bin container, one towards each side of the container, and each flexible element extends from the draw pole proximate to the front of the bin container up the front of the bin container to an attachment on the tailgate or a component that moves with the tailgate.

6. A bin according to claim 1, wherein the bin container tipping means comprises a brake that is operatively mounted on at least one wheel that can be selectively engaged by an operator to brake said at least one wheel, and wherein the bin container is tipped by applying the brake to the at least one wheel and then displacing the draw pole rearward by means of a towing vehicle which rearward displacement causes the bin container to tip.

7. A bin according to claim 6, wherein the brake comprises brake members applying a braking action to both wheels on the bin and the brake includes a controller for enabling a user to operate the brakes that is remote from the bin, and wherein the controller may be operatively coupled to the brake members by means of a cable.

8. A bin according to claim 1, wherein the bin container tipping means comprises a lifting means that is mounted on the draw pole and which can be operatively coupled to the bin container to lift the front of the bin container.

9. A bin according to claim 8, wherein the lifting means is a winch that is mounted on the draw pole and extends upwardly there from to a height above the floor of the bin container, and the winch has a cable attachment formation that can be releasably attached to a complementary formation on the bin container to lift the front of the container up.

10. A bin according to claim 1, wherein the bin container tipping means comprises a cam that operatively engages an underside of the floor of the bin container towards the front thereof and a lever extending away from the cam, whereby pivoting of the lever rotates the cam relative to the bin container and lifts the front of the container.

11. A bin according to claim 2, further including at least one arm having a front end and a rear end and the tailgate being mounted to each arm towards its rear end, and each arm being pivotally mounted to the bin container at a point spaced away from the rear end whereby pivoting of the arm/s on the bin container moves the tailgate between the closed and open positions.

12. A bin according to claim 11, wherein the tailgate includes two arms, one each resting on the upper edge of a side of the bin container, and the two arms are operatively connected to each other to form an arm frame.

13. A bin according to claim 12, wherein the arms are pivotally mounted on the upper edge of the bin container at a pivot point which is closer to the front than the rear of the bin container.

14. A bin according to claim 13, wherein the upper edges of the sides of the bin container slope up from the rear of the bin container to the pivot point and also slope up from the front of the bin container to the pivot point, whereby to provide clearance for the arms to move the tailgate from the closed to the open position without interference from the sides of the bin container, and wherein the sloping upper edges of the sides of the container effectively provide stop formations for stopping further movement of the arms when the tailgate reaches each of the open and closed positions.

15. A bin according to claim 16, having a said compression strut on each side of the bin container, each compression strut extending between the side of the bin container and a said arm on the associated side of the bin container, each strut being mounted to the bin container at a position rearward of the pivotal mounting of the arm to the bin container.

16. A bin according to claim 12, wherein the bin container further includes a lid for covering over the top of the container, and wherein the lid is mounted on the arm frame of the tailgate and moves with the arms when the tailgate moves between the open and closed positions.

17. A bin according to claim 16, wherein the lid comprises at least one lid portion that is pivotally mounted on the arm frame of the tailgate and movable between a closed position in which it rests on the arm frame and closes the top of the bin container and an upwardly extending open position in which it provides access to the interior of the bin container.

18. A bin according to claim 1, wherein the draw pole comprises left and right arms and each of said left and right arms is pivotally mounted to the support by means of a said pivotal coupling, and wherein the pivotal couplings are located forward of the wheels of the bin.

19. A bin according to claim 1, further including bin container locking means for releasably locking the bin container in the normal running position to ensure that it does not inadvertently move to the tipping position when it is being towed by a vehicle, and further including tailgate locking means for releasably locking the tailgate in the closed position to ensure that it does not inadvertently move to the open position when the bin is being towed by a vehicle on a road.

20. A bin mounted on wheels, the bin comprising:
a support having a pair of wheels mounted there to for displacing the support across a support surface;
a bin container rigidly mounted on the support, the bin container comprising a front and a rear and two sides extending between the front and the rear, the rear forming a tailgate that is capable of being moved from a closed position in which it closes off the sides and an open position in which it is moved away from the adjacent sides of the bin container to define an opening through which material can be loaded into the bin container and discharged from the bin container;
means for facilitating tipping of the bin container from a normal running position to a rearward tipping position in which the bin container slopes down in a rearward direction;
means for automatically moving the tailgate from the closed to the open position in response to tipping of the bin container into the rearward tipping position; and
a draw pole for attaching the bin to a towing vehicle, the draw pole being pivotally mounted to the support or the bin container and extending there from in a forward direction.

21. A bin mounted on wheels, the bin comprising:
a support having a pair of wheels mounted there to for displacing the support across a support surface, and a brake that is operatively mounted on at least one wheel that can be selectively engaged by an operator to brake said at least one wheel;
a bin container rigidly mounted on the support, the bin container comprising a front and a rear and two sides extending between the front and the rear, the rear forming a tailgate that is capable of being moved from a closed position in which it closes off the sides and an open position in which it is moved away from the adjacent sides of the bin container to define an opening through which material can be loaded into the bin container and discharged from the bin container;
means for automatically moving the tailgate from the closed to the open position in response to tipping of the bin container into the rearward tipping position; and
a draw pole for attaching the bin to a towing vehicle, the draw pole being pivotally mounted to the support or the bin container and extending there from in a forward direction;
wherein the bin container can be tipped from a travelling position to a rearward tipping position in which the bin container slopes down in a rearward direction by applying the brake to the wheels and then displacing the draw pole rearward with a towing vehicle and this causes the tailgate moving means to move the tailgate into the open position.
